(19) United States
(12) Patent Application Publication
(10) Pub. No.: US 2009/0316794 A1
(43) Pub. Date: Dec. 24, 2009

(54) IMAGE PROCESSING APPARATUS AND IMAGE PROCESSING METHOD

(75) Inventor: Yasuyuki Tanaka, Akishima-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/277,078

(22) Filed: Nov. 24, 2008

(30) Foreign Application Priority Data
Jun. 20, 2008 (JP) 2008-162356

(51) Int. Cl. H04N 7/12

(52) U.S. Cl. 375/240.24; 375/E07.076

(57) ABSTRACT

An image processing apparatus for processing image data by partitioning an image contained in the image data into a plurality of macro blocks, the apparatus includes: a determination module configured to detect an edge pixel for each of the macro blocks and determine a direction of an edge with respect to the detected edge pixel for each of the macro blocks; a smoothing module configured to perform smoothing process for each of pixels except the edge pixel to remove ringing noise; and a sharpening module configured to sharpen the image by performing interpolating process for interpolating the pixels based on the determined direction of the edge.

### CROSS-REFERENCE TO RELATED APPLICATIONS

This application is based upon and claims the benefit of priority from Japanese Patent Application No. 2008-162356, filed Jun. 20, 2008, the entire contents of which are incorporated herein by reference.

### BACKGROUND

1. Field

The present invention relates to an image processing apparatus, such as a personal computer, and to an image processing method for use with the image processing apparatus.

2. Description of the Related Art

Hitherto, audio-video (AV) devices, such as a digital versatile disc (DVD) player and a television (TV) device, and personal computers having similar AV functions have been developed.

Such devices need the functions of decoding and reproducing image data that is compression-coded using a block coding method, such as a Moving Picture Experts Group (MPEG) method. According to the block coding method such as an MPEG-method, processing, such as orthogonal transformation and quantization, is performed in units of blocks. In this case, high-frequency components of the orthogonally transformed image data are relatively roughly quantized. Accordingly, ringing noise tends to occur at the periphery of an edge portion of an image represented by the image data.

JP-A-2001-245179 discloses a technique of detecting an edge according to the difference value in pixel value between adjacent pixels and then performing smoothing on a block, which includes the detected edge, as a technique for reducing the ringing noise.

In addition, recently, a technique of super-resolution processing has been used. According to this technique, image enlargement processing and sharpening are performed. For example, JP-A-2006-155179 roughly describes the following technique. That is, an active region detection portion calculates local energy based on the signal level of an image signal. Then, the detection portion detects according to the value of the calculated local energy whether an edge is present. A result of the detection is output from the detection portion to a direction determination portion. Then, the direction determination portion determines the direction of the edge and outputs information representing the determined direction of the edge. In addition, the direction determination portion outputs pixel information to a directional interpolation portion. The direction determination portion interpolates pixels based on the information received from the direction determination portion using pixel values of pixels that are present in the determined direction of the edge.

However, the related techniques have disadvantages in that the sharing of information between a deringing process and a super-resolution process is insufficient, and that thus, there is redundant processing between the deringing process and the super-resolution process.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective diagram illustrating the appearance of an information processing apparatus according to an embodiment of the invention.

FIG. 2 is an exemplary block diagram illustrating an example of the system configuration of the information processing apparatus illustrated in FIG. 1.

FIG. 3 is an exemplary diagram illustrating the configuration of a video reproduction application program executed by the information processing apparatus illustrated in FIG. 1.

FIG. 4 is an exemplary flowchart illustrating a main process performed by the embodiment of the invention.

FIG. 5 is an exemplary diagram illustrating how to obtain macro block information, in order to explain advantages of the embodiment of the invention.

FIG. 6 is an exemplary flowchart illustrating deranging to be performed on a target pixel according to the embodiment of the invention.

### DETAILED DESCRIPTION

Various embodiments according to the invention will be described hereinafter with reference to the accompanying drawings. In general, according to one embodiment of the invention, there is provided an image processing apparatus for processing image data by partitioning an image contained in the image data into a plurality of macro blocks, the apparatus including: a determination module configured to detect an edge pixel for each of the macro blocks and determine a direction of an edge with respect to the detected edge pixel for each of the macro blocks; a smoothing module configured to perform smoothing process for each of pixels except the edge pixel to remove ringing noise; and a sharpening module configured to sharpen the image by performing interpolating process for interpolating the pixels based on the determined direction of the edge.

According to another aspect of the embodiment of the invention, there is provided an image processing method for processing image data by partitioning an image contained in the image data into a plurality of macro blocks, the method including: detecting of an edge pixel for each of the macro blocks; determining a direction of an edge corresponding to the detected edge pixel for each of the macro blocks; performing smoothing process for each of pixels expect the edge pixel to remove ringing noise; and performing interpolating process for interpolating the pixel based on the determined direction of the edge.

Hereinafter, an embodiment of the invention is described.

### Embodiment 1

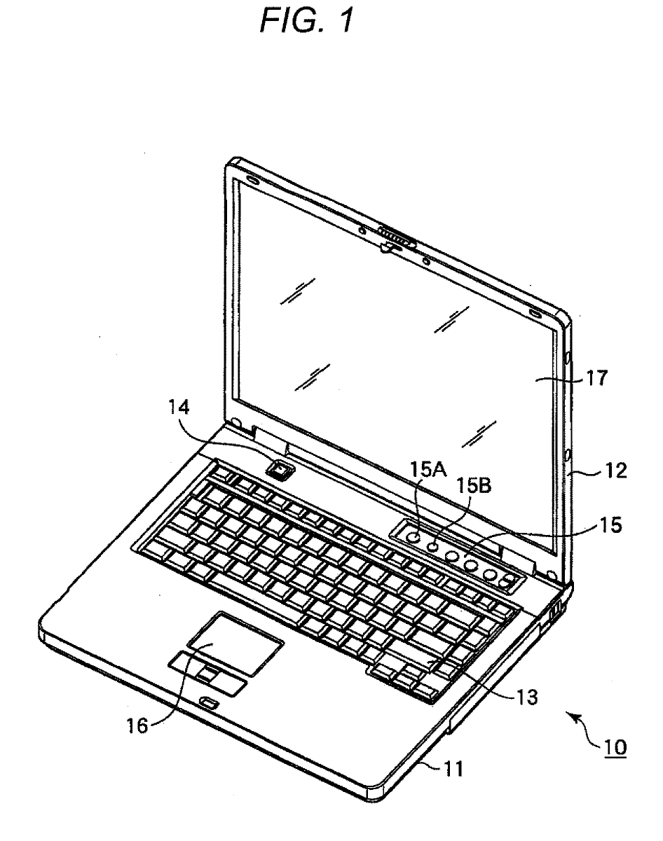

Embodiment 1 according to the invention is described hereinafter by referring to FIGS. 1 to 6.

Hereinafter, the embodiment of the invention is described with reference to the accompanying drawings.

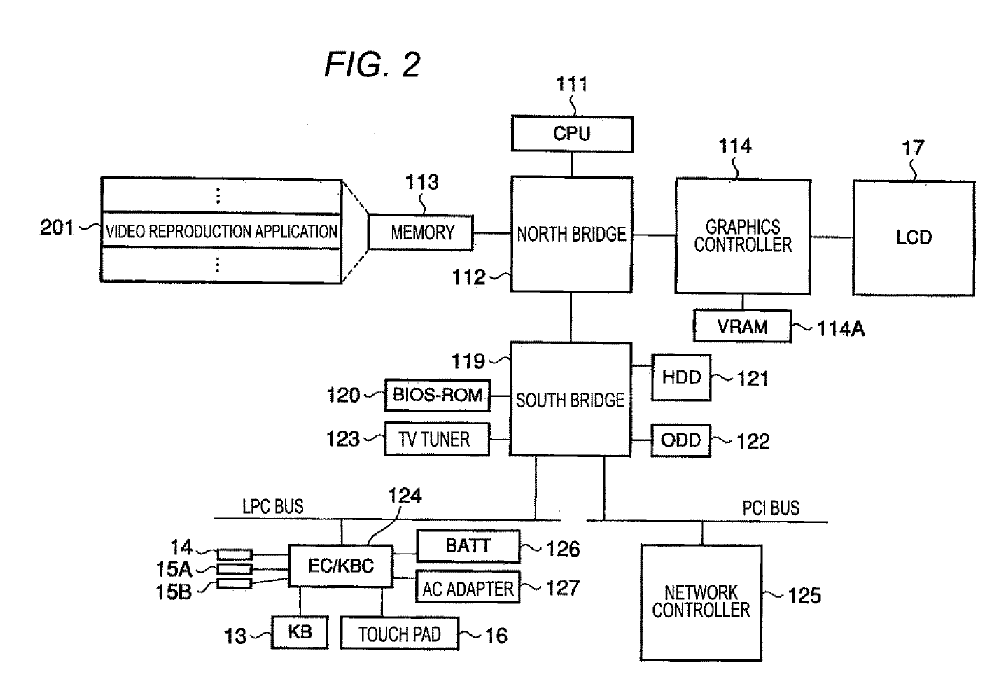

First, the configuration of an information processing apparatus according to one embodiment of the invention is described by referring to FIGS. 1 and 2. This information processing apparatus is implemented as a portable battery-drivable notebook type personal computer 10.

As illustrated in FIG. 1, the personal computer 10 is implemented as an apparatus that comprises a central processing unit (CPU), a graphics processing unit (GPU), an external storage unit (a hard disk drive (HDD), or a compact disc (CD)/DVD media), a display unit (e.g., a display device), and a network controller (e.g., an Internet connection). A deringing process and a super-resolution process are performed on the CPU or the CPU. Image/video information stored in the external storage unit or the network controller is converted by a decoder into information for performing a deringing process and a super-resolution process. The image/video information subjected to the deringing process and the super-resolution process is stored in the external storage unit after sent to the display unit or converted by an encoder.

FIG. 1 is a perspective view illustrating a state in which a display unit of the notebook type personal computer 10 is opened. The computer 10 includes a computer body 11 and a display unit 12. A display device including a liquid crystal display (LCD) 20 is incorporated into the display unit 12. The display screen of the LCD 20 is located substantially at the center of the display unit 12.

The display unit 12 is supported by the computer body 11 and is attached thereto turnably between an open position, in which the top surface of the computer body 11 is exposed, and a closed position in which the display unit 12 covers the top surface of the computer body 11. The computer body 11 includes a box-like thin case on the top surface of which a keyboard 13, a power button 14 for turning on/off the power supply of the computer 110, an input operation panel 15, and a touch pad 16 are arranged.

The input operation panel 15 is an input device for inputting an event corresponding to a pushed button thereof and has a plurality of buttons for respectively activating a plurality of functions. A group of such buttons includes a TV start-up button 15A, a DVD (Digital Versatile Disc) start-up button 15B. When the TV start-up button 15A is pushed down by a user, an application program for performing a TV function is automatically activated. The DVD start-up button 15B is a button for reproducing video contents recorded on a DVD. When the DVD start-up button 15B is pushed down, an application program for reproducing the video contents is automatically activated.

Next, the system configuration of the computer 10 is described below with reference to FIG. 2.

As illustrated in FIG. 2, the computer 10 includes a CPU 111, a north bridge 112, a main memory 113, a graphics controller 114, a south bridge 119, a basic input/output system read-only memory (BIOS-ROM) 120, a hard disk drive (HDD) 121, an optical disk drive (ODD) 122, a TV broadcast tuner 123, an embedded controller/keyboard controller IC (EC/KBC) 124, and a network controller 125.

The CPU 111 is a processor provided to control an operation of the computer 10. The CPU 111 executes an operating system (OS) program and various application programs, such as a video reproduction application program 201, which are loaded from the hard disk drive (HDD) 121 into the main memory 113.

The video reproduction application program 201 is a program for reproducing image data and has a function for decoding digital image data compression-coded by a block coding method such as an MPEG2 standard method (such digital image data is, e.g., broadcast program data received and compression-coded by the TV broadcast tuner 123, and MPEG2 video contents read from the optical disk drive (ODD) 122).

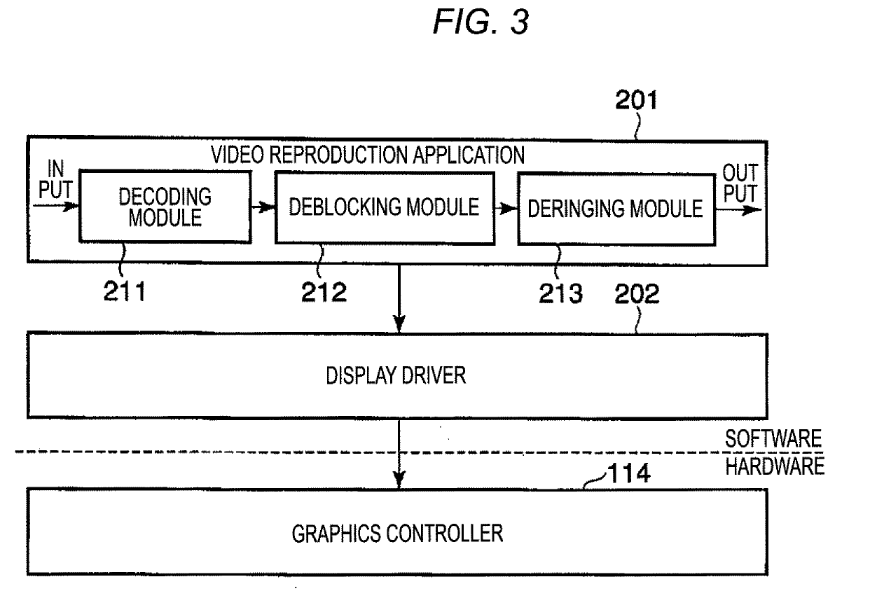

As illustrated in FIG. 3, the video reproduction application program 201 includes a decoding module 211, a deblocking module 212, and a deringing module 213.

The decoding module 211 is a software decoder for decoding moving image data compression-decoded by a block coding method, such as the MPEG2 standard method. The deblocking module 212 and the deringing module 213 are used to improve the picture quality of an image represented by the decoded moving image data. The deblocking module 212 performs a deblocking process for reducing block noises included in the decoded moving image data. The deringing module 213 is a module that performs a deringing process for reducing ringing noise included in an image represented by the deblocked moving image data. The deringed moving image data is sent to the graphics controller 114 via a display driver 202.

The CPU 111 executes the video reproduction application program 201 to thereby perform decoding, deblocking, and deringing on the data loaded into the memory 113.

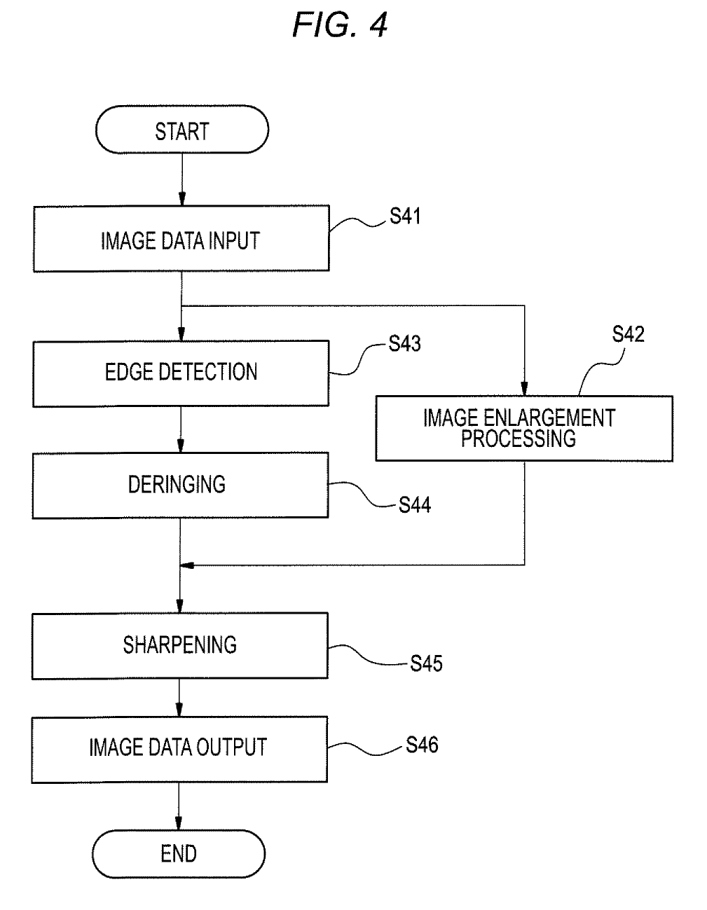

As shown in a flowchart illustrated in FIG. 4, in step S41, an image data input portion receives image/video data compressed in, e.g., the JPEG/MPEG format from an external storage device, or via a data broadcast (e.g., a terrestrial digital broadcast) or a network distribution.

Then, as illustrated in FIG. 4, in step S42, an image enlargement processing unit performs image enlargement processing on input image data to thereby increase the size of an image represented by the input image data to an assumed output image size.

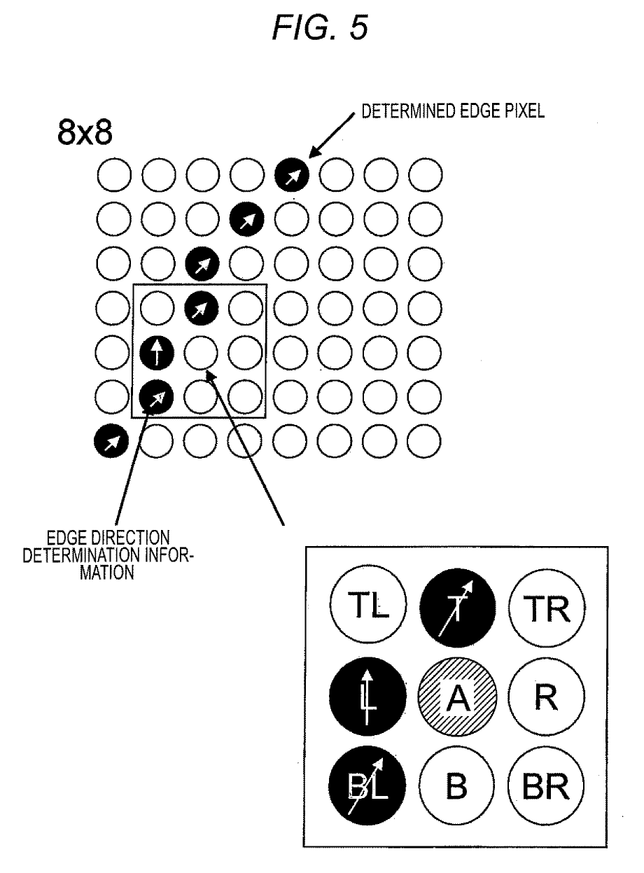

On the other hand, as illustrated in FIG. 4, in step S43, an edge detection/determination portion divides an input image represented by the input image data into macro blocks each having 8×8 pixels as illustrated in FIG. 5. Then, the edge detection portion detects whether an edge pixel is present in each macro block. In addition, the edge detection portion detects what direction an edge in each macro block extends in.

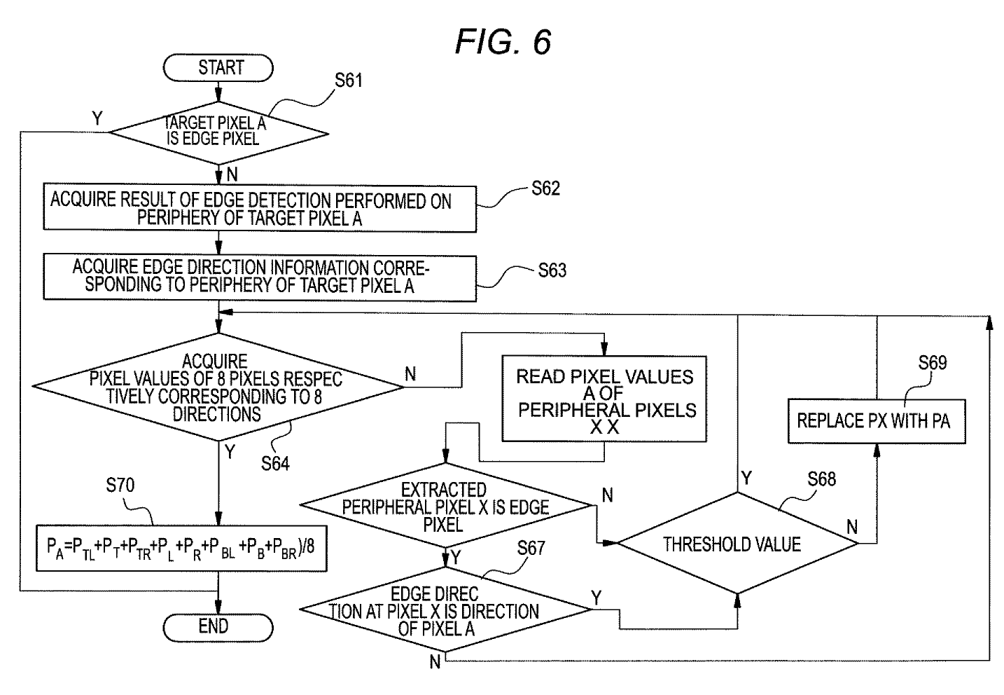

Further, as illustrated in FIG. 4, in step S44, smoothing is performed on the edge pixels detected by the edge detection/determination portion in each macro block. More specifically, according to a flowchart illustrated in FIG. 6, which will be described below, smoothing is performed on each of blocks each of which has 3×3 pixels and includes a target pixel A and 8 peripheral pixels that surround the target pixel A and that are respectively located in 8 peripheral directions from the target pixel A.

As illustrated in FIG. 4, in step S45, a sharpening portion performs pixel interpolating processing according to pixel information obtained by the edge detection/determination portion. The sharpness of the image is enhanced by obtaining information concerning the macro blocks subjected to the smoothing and providing a parameter to the sharpening portion.

As illustrated in FIG. 4, in step S46, an image data output portion sends image data representing an image subjected to the sharpening to the display unit and the external storage unit. The macro blocks are arranged in lengthwise and breadthwise to thereby constitute the image having the size of the display screen. The smoothing is performed depending upon the position of each block having 3×3 pixels, so that sometimes, the smoothing is performed astride adjacent macro blocks. In addition, in a case where a certain block having 3×3 pixels is located at an end of the screen in FIG. 5, if necessary, the smoothing is similarly performed using a means for virtually extrapolating pixels to the outside of the screen.

As illustrated in FIG. 6, if the target pixel A is an edge pixel (YES in step S61), the smoothing is not performed. If the target pixel A is not an edge pixel (NO in step S61), in steps S62 and S63, results of the edge detection performed on the peripheral pixels of the target pixel A and edge direction information corresponding to each of the peripheral pixels are obtained. If a peripheral pixel X is an edge pixel (YES in step S66), in step S67, it is determined whether an edge direction at the pixel X is the direction of the pixel A. If the peripheral pixel X is not an edge pixel, or if the edge direction at the pixel X is the direction of the pixel A, it is checked whether the difference between pixel values PA and PX is less than a threshold value. If the difference between pixel values PA and PX is not less than the threshold value (NO in step S68), in step S69, the pixel value PX is replaced with the pixel value PA. If the difference between pixel values PA and PX is less than the threshold value (YES in step S68), or if the edge direction at the peripheral pixel X is not the direction of the target pixel A, the pixel value PX is maintained. Upon completion of performing these determinations on the peripheral pixels respectively corresponding to 8 peripheral directions, in step S70, smoothing is performed using the following equation:

The pixel value PA (PTL+PT+PTR+PL+PR+PBL+PB+PBR)/8. Consequently, smoothing can be performed by eliminating the influence of the pixel values of the edge pixels, while maintaining the influence of pixels corresponding to each edge directed to the target pixel.

(Point 1: Method for Deringing to Enhance Advantages of Deringing)

Deringing is performed using edge detection/determination information obtained by the determination in the super-solution process. The determination is made without performing smoothing on the pixels determined as edge pixels. Whether an edge boundary pixel affects an edge pixel is determined. In the case illustrated in FIG. 4, the pixel BL is an edge pixel with respect to the pixel A. Further, the edge direction at the pixel BL is the direction of the target pixel A. Thus, it is determined that the target pixel A is affected by the edge pixel BL. The pixel value of the edge pixel BL is used as those of the peripheral pixels, which are used for the smoothing. On the other hand, although the pixels T and L are edge pixels, the edge direction at each of the pixels T and L is not the direction of the pixel A. Thus, it is determined that the target pixel A is not affected by the edge pixels T and L. Consequently, the pixel values of the edge pixels T and L are not used as those of the peripheral pixels to be used for the smoothing.

In the case of the related deringing, smoothing is uniformly performed on macro blocks, each of which is determined to include an edge. Accordingly, the pixel values of pixels corresponding to edges and edge boundaries are substantially uniform. However, in the case of the deranging according to the invention, it is additionally determined that smoothing is not performed on each edge, and that only influential ones of pixels on edge boundaries are taken into account. Consequently, an image is generated by removing ringing noise without making the pixel values on the edge and edge boundaries substantially uniform.

(Point 2: Specific Example of Reduction of Processing Time)

A result of determination made by a related deringing filter edge determination portion and information output from a super-solution edge determination portion are analyzed separately from each other. On the other hand, according to the invention, information obtained by an edge detection/determination portion is shared between the deringing process and the super-resolution process. Thus, a processing time for the edge detection/determination is reduced.

In the related apparatus, smoothing is performed on an edge. On the other hand, according to the present embodiment of the invention, a smoothing operation can be omitted. Consequently, a processing time can be reduced.

(Point 3: Example of Enhancement of Sharpness by Parameter Adjustment)

Differently from the related super-resolution process, the present embodiment of the invention can adjust the number of times of repeating the sharpening or the parameter for the sharpening speed to enhance the sharpness of an image. Consequently, the present embodiment can perform strong sharpening on deringed macro blocks by changing such parameters for the macro blocks.

(Advantages)

According to the present embodiment, the advantages of deringing can be enhanced using necessary information for super-resolution processing, e.g., information concerning the positions of edges and edge directions.

The necessary information is shared between the super-resolution process and the deringing process. Thus, edge detection/determination processing, which has been performed in both of the super-resolution process and the deranging process in the related apparatus, is performed only once in the apparatus according to the present embodiment of the invention. Consequently, the processing time of the entire apparatus can be reduced.

According to the present embodiment, strong sharpening is performed on macro blocks smoothed by a deringing filter. Thus, the degree of blurring of a smoothed region can be reduced.

According to the present embodiment, in the super-resolution process in which a low-resolution image is roughly enlarged and sharpened, smoothing is performed using the analyzed result of the edge detection/determination and the edge direction information.

Consequently, the following advantages can be obtained.

Point 1: An enlarged and sharpened image, from which ringing noises are removed, can be output, without smoothing the edge portion of the image subjected to the super-solution processing and the periphery thereof, by performing the method for deringing to enhance advantages of deringing.

Point 2: The processing time of the entire apparatus can be reduced by sharing the information between the deringing process and the super-solution process.

Point 3: The wholly sharpened image can be generated, without being blurred, by performing strong sharpening thereon, using information obtained by performing the deranging process on a specific block.

Incidentally, the invention is not limited to the aforementioned embodiment. The invention can be embodied by making various alterations thereof without departing from the gist thereof.

Further, various modifications of the invention can be made by appropriately combining a plurality of components disclosed in the foregoing description of the embodiment. For example, several components can be deleted from all the components described in the embodiment. Moreover, components of different embodiments can appropriately be combined with one another.

As described with reference to the embodiment, there is provided a more efficient processing technique that enables sufficient sharing of information between the deringing process and the super-resolution process.

The embodiment is possible to obtain a more efficient processing technique that enables sufficient sharing of information between the deringing process and the super-resolution process.

What is claimed is:

1. An image processing apparatus for processing image data by partitioning an image contained in the image data into a plurality of macro blocks, the apparatus comprising:
a determination module configured to detect an edge pixel for each of the macro blocks and determine a direction of an edge with respect to the detected edge pixel for each of the macro blocks;
a smoothing module configured to perform smoothing process for each of pixels except the edge pixel to remove ringing noise; and
a sharpening module configured to sharpen the image by performing interpolating process for interpolating the pixels based on the determined direction of the edge.

2. The apparatus according to claim 1, wherein the sharpening module is configured to adjust the number of times to repeat the sharpening process.

3. The apparatus according to claim 1, wherein the sharpening module is configured to adjust a parameter that determined a speed of the interpolating process.

4. An image processing method for processing image data by partitioning an image contained in the image data into a plurality of macro blocks, the method comprising:
detecting of an edge pixel for each of the macro blocks;
determining a direction of an edge corresponding to the detected edge pixel for each of the macro blocks;
performing smoothing process for each of pixels expect the edge pixel to remove ringing noise; and
performing interpolating process for interpolating the pixel based on the determined direction of the edge.

5. The method according to claim 4, wherein the interpolating process includes adjusting the number of times to repeat the interpolating process.

6. The method according to claim 4, wherein, the interpolating process includes adjusting a parameter that determines a speed of the interpolating process.
